(19) United States
(12) Patent Application Publication
(10) Pub. No.: US 2006/0281341 A1
(43) Pub. Date: Dec. 14, 2006

(54) ELECTRONICALLY FUNCTIONING DEVICE MODULE, INPUT DEVICE HAVING THE ELECTRONICALLY FUNCTIONING DEVICE MODULE, AND ELECTRONIC EQUIPMENT HAVING THE INPUT DEVICE

(76) Inventor: Kaoru Soeta, Tokyo (JP)

Correspondence Address: BRINKS HOFER GILSON & LIONE, P.O. BOX 10395, CHICAGO, IL, 60610, US

(21) Appl. No.: 11/421,720

(22) Filed: Jun. 1, 2006

(30) Foreign Application Priority Data
Jun. 14, 2005 (JP) 2005-173415

(51) Int. Cl. H01R 12/00

(52) U.S. Cl. 439/66

(57) ABSTRACT

An electronically functioning device module, an input device having the electronically functioning device module, and electronic equipment having the input device is provided. LEDs or a microphone device are mounted to a back surface of a seat member on which reversing plates are mounted.

### BACKGROUND

1. Field

An electronically functioning device module is provided.

2. Related Art

A LED configuration mounted to a circuit board of a cellular phone is disclosed in Japanese Unexamined Patent Application Publication No. 2002-110864. As shown in FIG. 3 of the same document, a wire is attached to the LED, and the wire is attached to an electrode on the board. The LED is packaged as shown in FIG. 3 in the above-described document. The LED packaged in this manner is bonded to a flexible printed board by reflow soldering according to the description (“0003”, “0004”, and so on in the document described above).

In the related art, the LED is directly mounted to a mother board. However, there are cases in which the LED can hardly be mounted directly to the mother board due to downsizing of the cellular phone, downsizing of the LED itself, or arrangement of parts on the mother board. When mounting the LED to the mother board by wire bonding or the like, there is a problem such that a large mounting space is required for the LED.

### SUMMARY

An electronically functioning device module whereby an electronically functioning device can be easily mounted, an input device in which the electronically functioning device module, and electronic equipment provided with the input device is provided.

An electronically functioning device module includes at least one electronically functioning device supported on a back surface of a supporting member that supports a reversing plate that is reversed by being pressed, and is characterized in that a resilient contact point is mounted to the electronically functioning device.

By supporting the electronically functioning device on a back surface of a sheet member on which the reversing plate is mounted, and providing the resilient contact point on the electronically functioning device, the electronically functioning device can be mounted easily to a mother board or the like without increasing a mounting space.

Preferably, the reversing plate is formed of a dome-shaped metal plate.

An electronically functioning device module in the invention includes at least one electronically functioning device on a back surface of at least one supporting member that constitutes electronic equipment and is characterized in that a resilient contact point is mounted to the electronically functioning device.

By supporting the electronically functioning device on the back surface of the supporting member that constitutes the electronic equipment, and providing the resilient contact point on the electronically functioning device, the electronically functioning device can easily be mounted to the mother board or the like without increasing the mounting space.

Preferably, the electronically functioning device is a light-emitting device. Alternatively, the electronically functioning device is preferably a microphone.

Preferably, the resilient contact point and an electrode are connected in conduction via a bump by mounting the bump to the resilient contact point, forming a recess on the electronically functioning device, the electrode is provided in the recess, and inserting the bump into the recess, whereby the resilient contact point can be mounted easily to the electronically functioning device. Preferably, the bump is press-fitted to the recess, whereby the resilient contact point can be supported reliably on the electronically functioning device.

Preferably, the resilient contact point is formed so as to project from a proximal end to a distal end in a spiral shape.

An input device according to the invention includes any one of the above-described electronically functioning device module and a member having an electrode, and is characterized in that the electrode and the electronically functioning device module are opposed to each other and the resilient contact point and the electrode are connected in conduction.

By the provision of the resilient contact point, the resilient contact point and the electrode can be connected adequately in conduction without particularly connecting the resilient contact point and the electrode with soldering or the like.

The member having the electrode is a mother board, (for example) and the electronically functioning device module opposes the mother board so that the resilient contact point and the electrode are connected in conduction. In this case, when the electronically functioning device module having the reversing plate formed of a dome-shaped metal plate is used, preferably, a supporting electrode that is connected to a proximal portion of the reversing plate and a central electrode that comes in contact with the reversing plate when the reversing plate is reversed are formed on the mother board. Accordingly, when the reversing plate is pressed and the reverting plate is reversed, and hence the reversing plate and the central electrode come in contact with each other, switching input is enabled.

A configuration including, for example, the electronically functioning device module, the member having the electrode and the mother board, wherein the electronically functioning device module opposes the electrode so that the resilient contact point and the electrodes are connected in conduction, and the mother board is arranged on the lower side of the member having the electrode is also applicable.

In this case, when the electronically functioning device module having the reversing plate formed of a dome-shaped metal plate is used, preferably, a supporting electrode that is connected to a proximal portion of the reversing plate and a central electrode that comes in contact with the reversing plate when the reversing plate is reversed are formed on the member having the electrode. Accordingly, when the reversing plate is pressed and the reversing plate is reversed, and hence the reversing plate and the central electrode come in contact with each other, switching input is enabled.

Electronic equipment is characterized in that the input device described above is provided. The electronic equipment is preferably portable electronic equipment. More specifically, the portable electronic equipment is a cellular phone.

In this embodiment, at least one electronic functioning device such as an LED is supported on a back surface of the supporting member that supports the reversing plates which is reversed by being pressed. The electronic functioning device includes the resilient contact point mounted thereto. Accordingly, the electronic functioning device can be mounted easily to the mother board or the like without increasing the mounting space. It is also possible to use the electronically functioning device module and the input device using the same in the invention for the portable electronic equipment such as the cellular phone or the like, whereby downsizing of the electronic equipment can be achieved.

### DRAWINGS

FIG. 1 is a partial front view of a cellular phone;

FIG. 2 is a partial perspective view of an input device disposed under an operating surface of the cellular phone shown in FIG. 1;

FIG. 3 is a partial cross-sectional view of an operating unit of the cellular phone taken along a line III-III in a direction parallel to the direction of the height and viewed in the direction indicated by an arrow in FIG. 2, showing particularly a state before respective members that constitute the operating unit are joined;

FIG. 4 is a partial cross sectional view of the operating unit showing a state in which the respective members are joined from the state shown in FIG. 3;

FIG. 5 is a partial perspective view of the input device having a different configuration from the one shown in FIG. 2;

FIG. 6 is a partial cross-sectional view of the operating unit of the cellular phone taken along a line VI-VI in a direction parallel to the height and viewed in the direction indicated by an arrow in FIG. 5, showing at a state before joining the respective members that constitute the operating unit;

FIG. 7 is a partial cross-sectional view of an LED (light-emitting diode) taken along the direction in parallel with the direction of the height (a resilient contact point is shown in a side view);

FIG. 8 is a partial cross-sectional view of the LED in a case in which a resilient contact point different from FIG. 7 is employed, showing in particular a state before applying heat processing;

FIG. 9 is a partial cross-sectional view of the LED showing a state after having applied heat processing from a state shown in FIG. 8;

FIG. 10 is a partial cross-sectional view of the LED in a state in which a resilient contact point different from FIG. 7 to FIG. 9 is employed;

FIG. 11 is a partial cross-sectional view of an electronic function element module taken along the direction in parallel with the direction of the height when an organic EL is employed instead of the LED; and

FIG. 12 is a partially enlarged side view of a resilient contact point module.

### DESCRIPTION

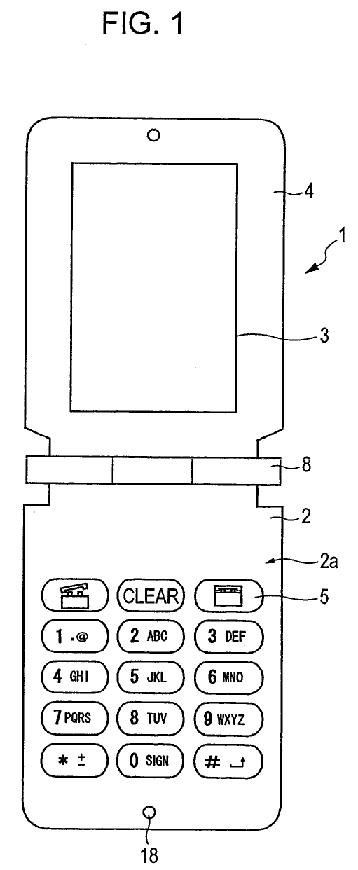

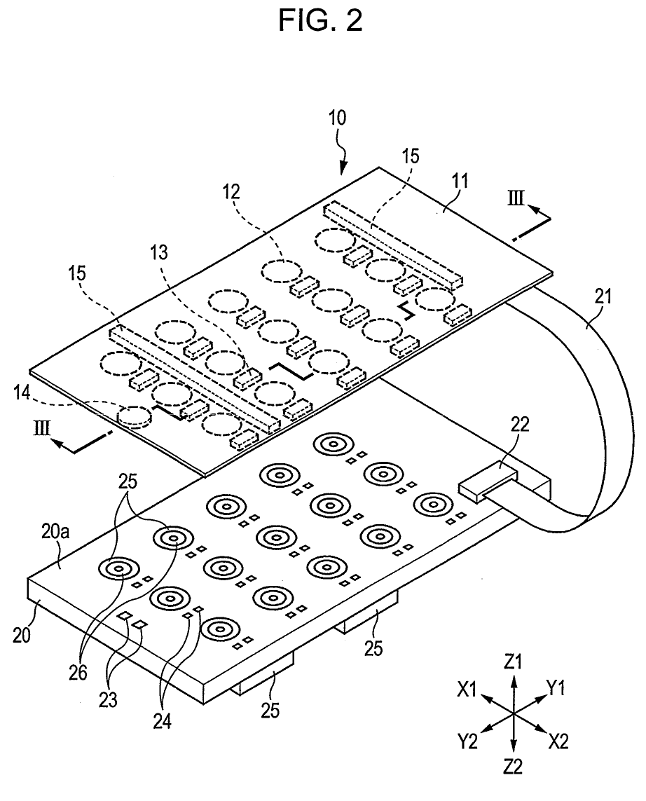

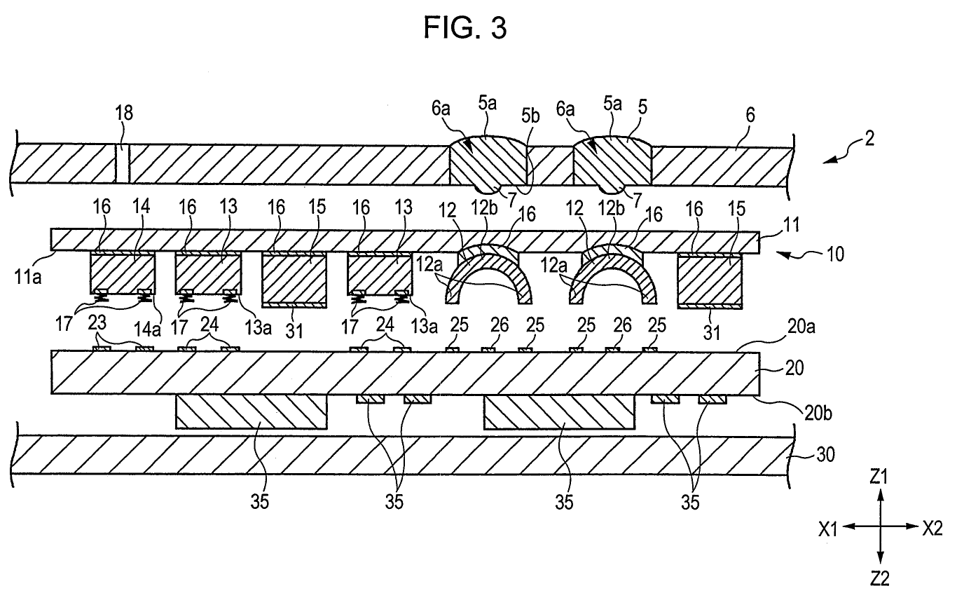

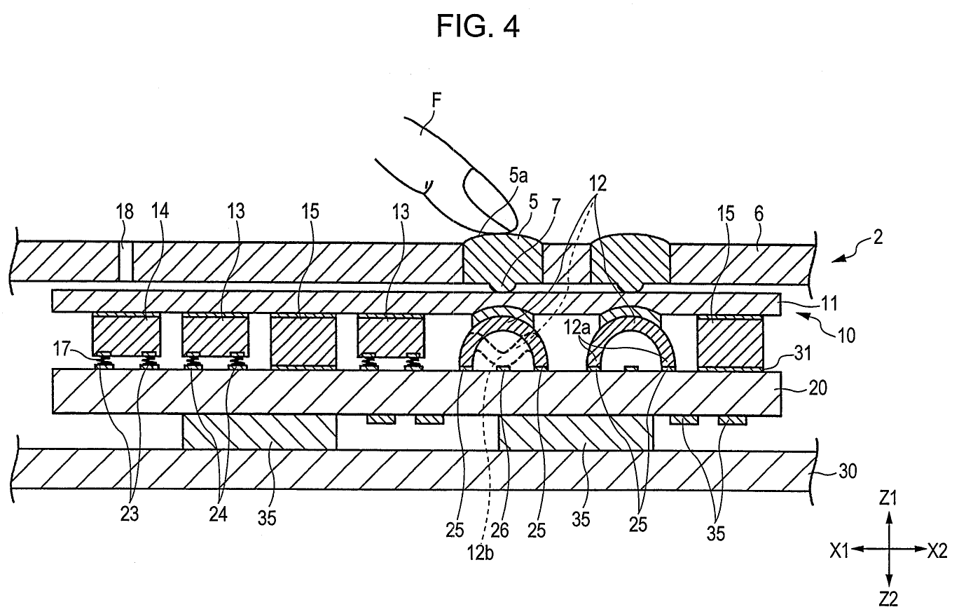

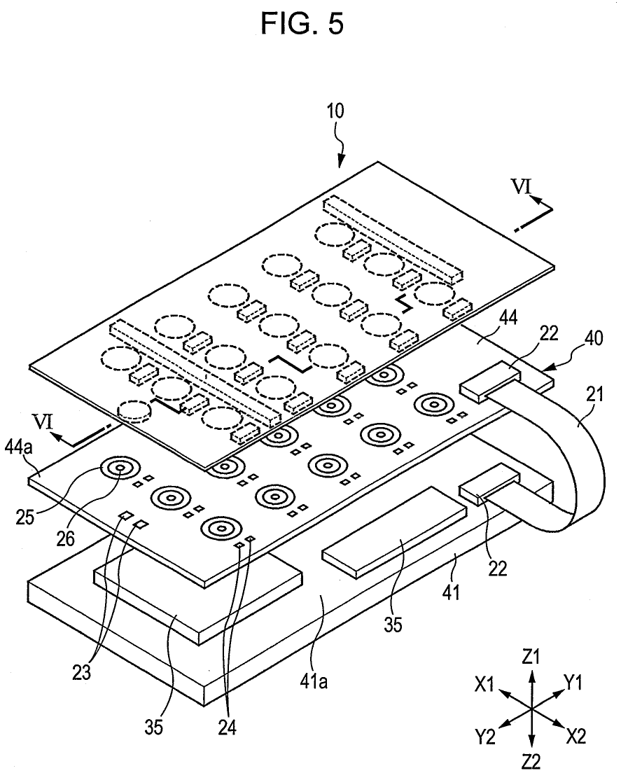

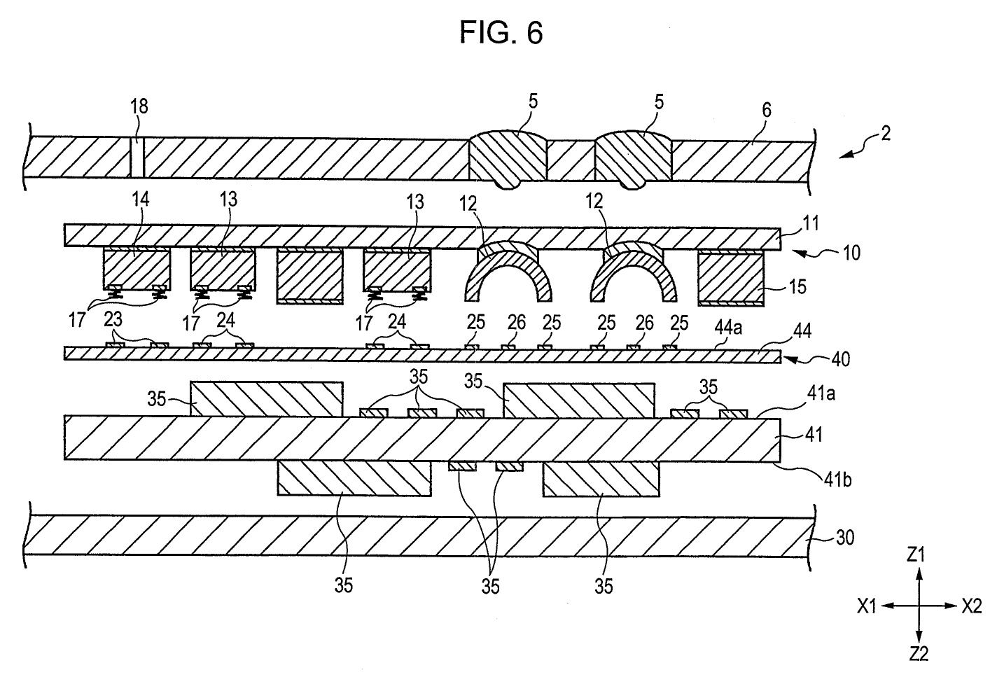

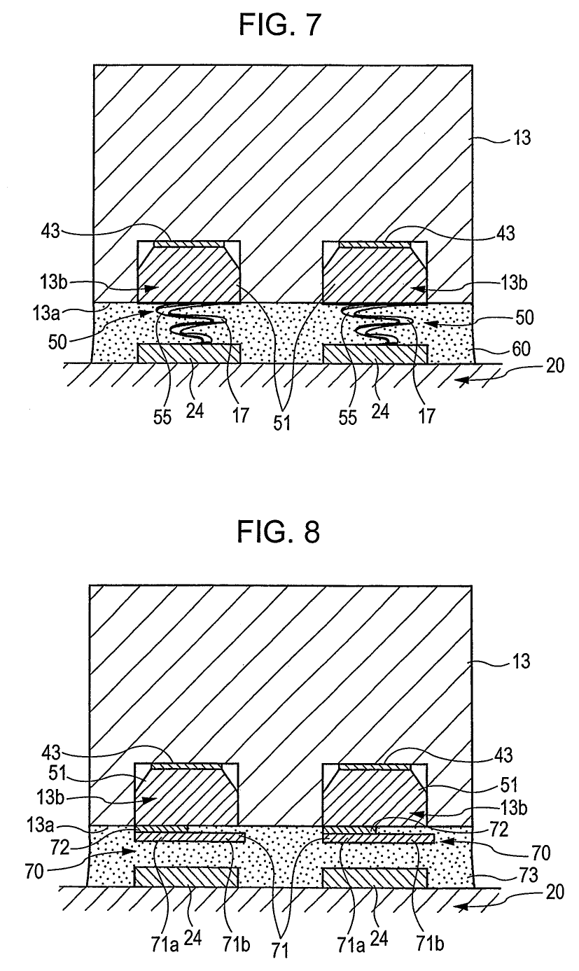

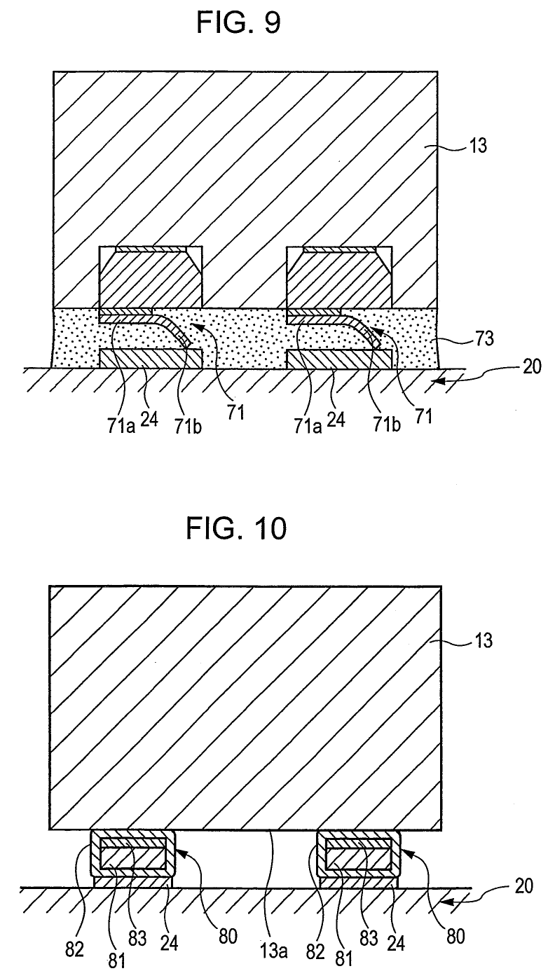

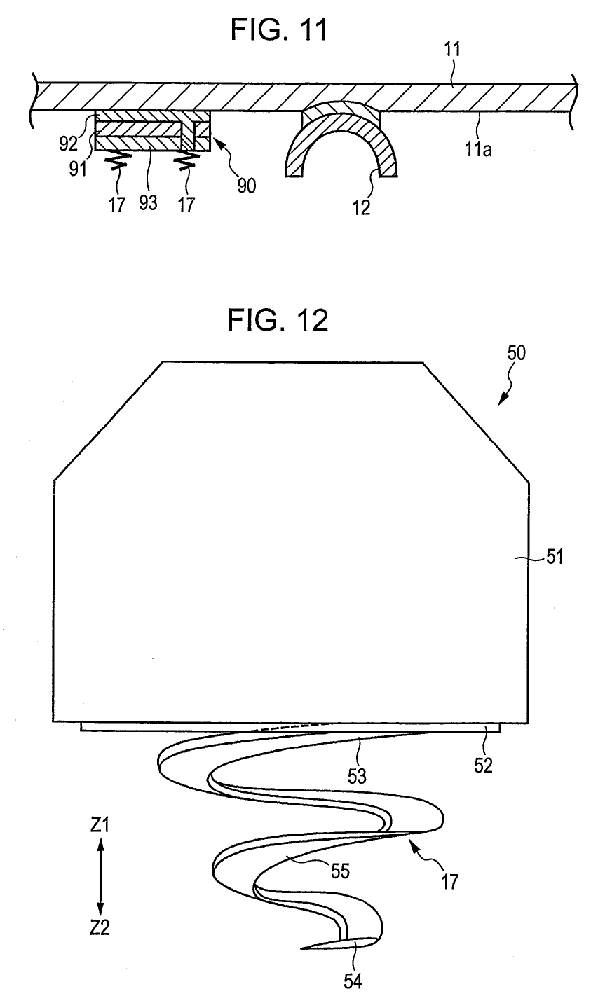

FIG. 1 is a partial front view of a cellular phone; FIG. 2 is a partial perspective view of an input device disposed under an operating surface of the cellular phone shown in FIG. 1; FIG. 3 is a partial cross-sectional view of an operating unit of the cellular phone taken along a line III-III in a direction parallel to the direction of the height and viewed in the direction indicated by an arrow in FIG. 2, showing particularly a state before respective members that constitute the operating unit are joined; FIG. 4 is a partial cross sectional view of the operating unit showing a state in which the respective members are joined from the state shown in FIG. 3; FIG. 5 is a partial perspective view of the input device having a different configuration from the one shown in FIG. 2; FIG. 6 is a partial cross-sectional view of the operating unit of the cellular phone taken along a line VI-VI in a direction parallel to the height and viewed in the direction indicated by an arrow in FIG. 5, showing at a state before joining the respective members that constitute the operating unit; FIG. 7 is a partial cross-sectional view of an LED (light-emitting diode) taken along the direction in parallel with the direction of the height (a resilient contact point is shown in a side view); FIG. 8 is a partial cross-sectional view of the LED in a case in which a resilient contact point different from FIG. 7 is employed, showing in particular a state before applying heat processing; FIG. 9 is a partial cross-sectional view of the LED showing a state after having applied heat processing from a state shown in FIG. 8; FIG. 10 is a partial cross-sectional view of the LED in a state in which a resilient contact point different from FIG. 7 to FIG. 9 is employed; FIG. 11 is a partial cross-sectional view of an electronic function element module taken along the direction in parallel with the direction of the height when an organic EL is employed instead of the LED; and FIG. 12 is a partially enlarged side view of a resilient contact point module.

A Direction X1-X2 indicates the widthwise direction, a direction Y1-Y2 indicates the lengthwise direction, a direction Z1-Z2 indicates the height direction, and the respective directions have an orthogonal relation with respect to the remaining two directions.

The cellular phone 1 shown in FIG. 1 includes an operating unit 2 having an operating surface 2a, and a display unit 4 having a display 3. In the cellular phone 1 shown in FIG. 1, the operating unit 2 and the display unit 4 are rotatably supported via a hinge portion 8.

As shown in FIG. 1, a plurality of input buttons 5 are provided on the operating surface 2a of the operating unit 2. As shown in FIG. 3, the operating buttons 5 are inserted into through holes 6a formed on an upper case 6 of a case (housing) that constitutes an appearance of the operating unit 2 of the cellular phone 1, and numeric characters or alphabets are provided by printing or the like on surfaces 5a (operating surfaces) of the input buttons 5. A projection 7 is formed on a back surface 5b of each input button 5 so as to extend downward (direction shown by Z2 in the drawing) as shown in FIG. 3.

As shown in FIG. 3, an LED/microphone device (electronic function element module) sheet 10 is provided on a lower side of the upper case 6. As shown in FIG. 2 and FIG. 3, the LED/microphone device sheet 10 includes a sheet member (supporting member) 11 formed by an insulating sheet such as polyimide resin, reversing plates 12, LEDs (Light Emitting Diodes) 13, a microphone device 14 and spacers 15. The reversing plates 12 are provided right below the input buttons 5, and as shown in FIG. 2 and FIG. 3, the reversing plates 12 are joined to a back surface 11a of the sheet member 11 via an adhesive agent 16. The reversing plate 12 is formed of a metal plate of a dome shape (or diaphragm shape). The reversing plates 12 are metal contact switches or the like formed by punching, for example, a thin metal plate (for example, stainless steel plate) by high-precision press.

As shown in FIG. 2 and FIG. 3, the LEDs 13 and the microphone device 14, which is an electronically functioning device, are bonded to the back surface 11a of the seat member 11 via the adhesive agent 16. The microphone device 14 is provided right under a through hole 18 formed on the upper case 6, and the position of the through hole 18 serves as a “microphone” for talking. The LEDs 13 are provided one for each reversing plate 12 on the right side (X2 side in the drawing) thereof, as shown in FIG. 2, and the position and the number of the LED 13 can be set as needed. As shown in FIG. 3, resilient contact points 17 are provided on lower surfaces 13a, 14a of the LEDs 13 and the microphone device 14. The spacers 15 are also bonded to the back surface 11a of the sheet member 11 via the adhesive agents 16, and the spacers 15 are provided on the back surface 11a of the sheet member 11 where the reversing plates 12, the LEDs, 13 and the microphone devices 14 are not provided. Although the planer shape (a plane having the direction X1-X2 and the direction Y1-Y2) of the microphone device 14 has a substantially circular shape, it is not limited thereto. Although the planer shape (a plane having the direction X1-X2 and the direction Y1-Y2) of the LED 13 has a substantially rectangular shape, it is not limited thereto.

As shown in FIG. 2 and FIG. 3, a mother board 20 is arranged on the lower side of the LED/microphone device sheet 10. The mother board 20 and the sheet member 11 are connected by a flexible printed board 21 mounted to a connector 22.

As shown in FIG. 2 and FIG. 3, a number of electrodes are formed into a pattern on a surface 20a of the mother board 20. Electrodes 23 formed on the surface 20a of the mother board 20 are formed at positions opposing to the resilient contact points 17 provided on the lower surface 14a of the microphone device 14 in the height direction (the direction Z1-Z2 in the drawing). Electrodes 24 formed on the surface 20a of the mother board 20 are formed at positions opposing to the resilient contact points 17 provided on the lower surface 13a of the LED 13 in the height direction (the direction Z1-Z2 in the drawing). Electrodes 25 formed on the surface 20a of the mother board 20 (hereinafter referred to as supporting electrodes) are formed at positions opposing to base portions 12a of the reversing plates 12 in the height direction (the direction Z1-Z2 in the drawing). Since the base portions 12a are formed substantially into a ring shape, the supporting electrodes 25 are also formed into the substantially ring shape (see FIG. 2). As shown in FIG. 2 and FIG. 3, central electrodes 26 are formed at centers of the respective supporting electrodes 25. The central electrodes 26 are formed at positions opposing exactly to apexes 12b of the reversing plates 12 in the height direction (the direction Z1-Z2 in the drawing).

As shown in FIG. 2 and FIG. 3, a plurality of semiconductor devices 35 are mounted to a back surface 20b of the mother board 20. The semiconductor devices 35 include a memory, a driver, a capacitor, an inductor, a filter and so on. The semiconductor device 35 may be mounted in a state of a bear chip, or may be mounted in a state of an IC package. In this manner, in the embodiment shown in FIG. 2 and FIG. 3, the back surface 20b of the mother board 20 is used as a mounting surface for the semiconductor devices 35.

Reference numeral 30 designates a lower case of a case (enclosure) that constitutes the appearance of the operating unit 2 of the cellular phone 1.

As shown in FIG. 4, the LED/microphone device sheet 10 and the mother board 20 respectively are interposed between the upper case 6 and the lower case 30. At this time, an adhesive agent 31 is applied on a lower surface of the spacer 15 in advance, and the sheet member 11 is fixedly bonded to the mother board 20 via the adhesive agent 31. A structure in which such the adhesive agent 31 is also applied to the base portions 12a of the reversing plates 12, and between the base portions 12a and the supporting electrodes 25 are fixedly bonded by the adhesive agent 31 is also applicable. However, in such a case, the adhesive agent 31 is required to be an anisotropic conductive paste, whereby the reversing plates 12 and the supporting electrodes 25 are adequately conducted. It is also possible to join the base portions 12a and the supporting electrodes 25 with reflow soldering.

As shown in FIG. 4, the resilient contact points 17 provided on the lower surfaces 13a, 14a of the LEDs 13 and the microphone device 14 come into abutment with the electrodes 23, 24 opposing thereto in the height direction (the direction Z1-Z2 in the drawing). Generated slightly between the LED/microphone device sheet 10 and the mother board 20 interposed between the upper case 6 and the lower case 30 is a pressing force approaching to each other. Therefore, the pressing force serves to compress the resilient contact points 17 provided on the lower surfaces 13a, 14a of the LEDs 13 and the microphone device 14 and, consequently, the resilient contact points 17 are apt to restore the original shape, and hence a resilient repulsive force is generated in the vertical direction (direction indicated by Z1-Z2) in the drawing. With this resilient repulsive force, the resilient contact points 17 are pressed strongly against the electrodes 23, 24, whereby the resilient contact points 17 and the electrodes 23, 24 are reliably conducted. The upper case 6 and the lower case 30 are engaged with an engaging portion, not shown.

When an operator presses the input button 5 downward in the drawing with a finger (an operating body) F, the input button 5 moves downward, and the projection 7 formed on the lower surface of the input button 5 presses the sheet member 11 downward (in the direction Z2 in the drawing). Accordingly, the sheet member 11 is bent and deformed into a recessed state. The reversing plate 12 is reversed by a pressing force at this time and, consequently, a pressing reactive force is generated on the reversing plate 12. Since this pressing reactive force is transmitted to the finger of the operator as a click feeling, the operator can recognize that he/she has surely pressed the button. Simultaneously, a conducting state in which a back surface (lower surface) of the apex 12b of the dome portion of the reversing plate 12 comes in contact with the center electrode 26 is achieved. Therefore, only the center electrode 26 that comes in contact with the reversing plate 12 is set to a predetermined voltage and, which input button 5 is operated is detected by a control unit, not shown.

Timing of voltage supply to the LEDs 13 is controlled by the control unit described above. For example, it is controlled such that a voltage is applied to all the LEDs 13 when the operating unit 2 and the display unit 4 of the cellular phone 1 is opened from the closed state, whereby all the LEDs 13 are illuminated and hence displays of numerical characters, alphabets and so on of all the input buttons 5 are brightly illuminated when the operating unit 2 and the display unit 4 of the cellular phone 1 are opened. Alternatively, as described above, it may be controlled in such a manner that when the reversing plate 12 is reversed and the fact that a certain input button 5 is pressed is detected, the control unit emits a signal that gives instruction to provide a voltage only to the LED 13 which is adjacent to the pressed input button 5, whereby only the certain LED 13 is illuminated.

In an embodiment shown in FIG. 5 and FIG. 6, the LED/microphone device sheet 10, an electrode sheet (member having electrodes) 40, and a mother board 41 are provided between the upper case 6 and the lower case 30 of the operating unit 2. The configurations of the LED/microphone device sheet 10 are the same as those in FIG. 2. In FIG. 5 and FIG. 6, the electrode sheet 40 is provided on a lower side of the LED/microphone device sheet 10. The electrode sheet 40 has a structure in which a conductive pattern is formed on a surface 44a of an insulative sheet member (supporting member) 44 formed of polyimide resin or the like. The conductive pattern is formed with electrodes at positions opposing to the LEDs 13, the microphone device 14 and the reversing plates 12 in the height direction (the direction Z1-Z2 in the drawing). The electrodes are formed in the same pattern as the electrodes formed on the surface 20a of the mother board 20 shown in FIG. 2. As shown in FIG. 5, the electrode sheet 40 and the mother board 41 are connected by the flexible printed board 21 mounted to the connector 22. As shown in FIG. 5 and FIG. 6, a plurality of the semiconductor devices 35 are mounted to a surface 41a of the mother board 41. The semiconductor devices 35 include the memory, the driver, the capacitor, the inductor, the filter and so on. The semiconductor device 35 may be mounted in a state of the bear chip or may be mounted in a state of the IC package. In the embodiment shown in FIG. 5 and FIG. 6, the surface 41a of the mother board 41 is used as a mounting surface for the semiconductor device 35. As shown in FIG. 6, the plurality of semiconductor devices 35 are mounted also on a back surface 41b of the mother board 41. In other words, in the embodiment shown in FIG. 5 and FIG. 6, the upper and lower surfaces of the mother board 41 are used as the mounting surfaces for the semiconductor device 35. In the embodiment shown in FIG. 5 and FIG. 6, when the function of the cellular phone 1 is a multi function, for example, when providing not only the normal talking function or mailing function, but also a camera function, a web function, a navigation function, and so on in the cellular phone 1, it is also necessary to mount a number of semiconductor devices 35 correspondingly. In this case, an internal structure in which the upper and lower surfaces of the mother board 41 can be used as the mounting surface of the semiconductor device 35 as shown in FIG. 5 and FIG. 6 but not the internal structure of the operating unit 2 shown in FIG. 2 to FIG. 4 is preferably applied.

FIG. 7 is an enlarged partial cross-sectional view of the LED 13 shown in FIG. 4. As shown in FIG. 7, recesses 13b are formed on the lower surface 13a of the LED 13, and electrodes 43 are formed on ceiling surfaces of the recesses 13b.

FIG. 12 shows a contact point module 50, and the contact point module 50 includes the resilient contact point 17 and a bump 51. The resilient contact point (spiral contact element) 17 includes a conductive mount portion 52 formed substantially in a ring shape, and a conductive resilient arm 55 connected integrally with the mount portion 52 and extending from a proximal end 53 that corresponds to a boundary with respect to the mount portion 52 to a distal end 54 thereof in a spiral shape. The mount portion 52 is formed into a planar shape having a predetermined thickness, and the resilient arm 55 is formed downward (in the direction Z2 in the drawing) three-dimensionally in the spiral shape. The distal end 54 is located substantially at a center of the spiral shape in plan view.

As shown in FIG. 12, the resilient contact point 17 is formed by an etching method or an electroplating method. With the etching method, the same shape as the resilient contact point is formed by etching a thin plate-shaped copper film, and reinforcing plating with nickel, nickel-phosphorus is applied on a surface thereof. Alternatively, it can also be formed by a layered product of copper and nickel, or a layered product of copper and nickel-phosphorus. In this configuration, nickel or nickel-phosphorus mainly exhibits a resilient property, and copper functions to lower the specific resistance.

The resilient contact point 17 is formed by plating a copper layer, or by forming a layered film by plating copper and nickel or copper and nickel-phosphorus continuously.

The resilient contact point 17 including the resilient arm 55 is first formed into a planar shape as the mount portion 52. The mount portion 53 and the resilient arm 55 are formed by any one of the methods shown above. Subsequently, the portion of the resilient arm 55 is formed three dimensionally as shown in FIG. 12. The three-dimensional formation is performed mechanically by a jig or the like.

As shown in FIG. 12, the bump 51 is bonded to the mount portion 52 of the resilient contact point 17 with, for example, conductive adhesive agent. The bump 51 is formed by a conductive material. The bump 51 may be a solder bump.

As shown in FIG. 7, the contact point module 50 is press-fitted into the recess 13b of the LED 13 in a state of being positioned upwardly of the resilient contact point 17. Accordingly, the resilient contact point 17 can be fixed and supported by the LED 13 adequately. Since the bump 51 is formed of a conductive material, the electrode 43 and the bump 51 are conducted with each other, and the resilient arm 55 of the resilient contact point 17 connected to the bump 51 in conduction is connected in conduction to the electrode 24 formed on the surface 20a of the mother board 20.

As described above, the resilient arm 55 of the resilient contact point 17, being applied with a pressing force, is in a slightly compressed state in comparison with a state in which the resilient arm 55 is not applied with the pressing force as shown in FIG. 12, and the resilient arm 55 makes attempt to restore the original shape, thereby generating a resilient repulsive force in the vertical direction (in the direction Z1-Z2 in the drawing). Consequently, the resilient arm 55 of the resilient contact point 17 is pressed against the electrode 24 of the mother board 20 adequately, so that the resilient arm 55 and the electrode 24 are connected in an adequately conducted state.

As shown in FIG. 7, an adhesive agent 60 is interposed between the LED 13 and the mother board 20, and hence the LED 13 and the mother board 20 are fixedly bonded. The adhesive agent 60 is a anisotropic conductive adhesive agent, and the resilient contact point 17 and the electrode 24 are maintained in an adequately conducted state. The adhesive agent 60 may be a non-conductive adhesive agent, and in this state, it is preferable to fill the non-conductive adhesive agent into a space where the resilient contact point 17 and the electrode 24 are formed so as to avoid interposition of the adhesive agent 60 between the resilient contact point 17 and the electrode 24. The adhesive agent 60 may not be interposed between the LED 13 and the mother board 20. In FIG. 7, although a configuration of the LED 13 has been described, the microphone device 14 is also formed into the same configuration as the LED 13. It is also possible to fixedly bond the LED 13 and the microphone 14 to the electrode sheet 40 shown in FIG. 6 with the adhesive agent 60 as in the case shown in FIG. 7.

In the embodiment shown in FIG. 8, the recess 13b is formed on the lower surface 13a of the LED 13, and the bump 51 that constitutes a contact point module 70 is press-fitted into the recess 13b, whereby the bump 51 and the electrode 43 formed in the recess 13b are connected in conduction.

In an embodiment shown in FIG. 8, a resilient contact point 71 is formed on the lower surface of the bump 51 via a sacrifice layer 72. The sacrifice layer 72 is formed of resin layer or the like in which Ti or conductive filler is mixed. Different internal stresses are applied on an upper surface side and a lower surface side of the resilient contact point 71. More specifically, a tensile stress is applied to the upper surface side of the resilient contact point 71 and a compressing stress is applied to the lower surface side. The resilient contact point 71 is formed of NiZr alloy (added with Ni on the order of 1 at %), MoCr and so on. The different internal stresses can be applied to the upper surface side and the lower surface side of the resilient contact point 71 by forming the resilient contact point 71 by the sputter deposition while changing a vacuum gas pressure (for example, Ar gas is used) gradually when forming the resilient contact point 71 by the spatter deposition.

The resilient contact point 71 is composed of a mount portion 71a and a resilient arm 71b. As shown in FIG. 8, the sacrifice layer 72 is interposed between the mount portion 71a and the bump 51. However, the sacrifice layer 72 is not interposed between the resilient arm 71b and the bump 51.

In the embodiment shown in FIG. 8, an adhesive agent 73 is interposed between the LED 13 and the mother board 20. The adhesive agent 73 is, for example, an anisotropic conductive adhesive agent. In FIG. 8, the resilient arm 71b and the electrode 24 formed on the mother board 20 are not connected in conduction. Heat treatment is applied in the state shown in FIG. 8.

By the heat treatment, the resilient arm 71b that is not fixedly supported by the bump 51 with the intermediary of the sacrifice layer 72 is bent and deformed due to the difference in the internal stress and, more specifically, since a compressing stress is applied to a lower surface side of the resilient arm 71b and a tensile stress is applied to an upper surface side of the resilient arm 71b, the resilient arm 71b is bent downward as shown in FIG. 9 by the heat treatment. In FIG. 9, the resilient arm 71b comes into abutment with the electrode 24, and hence the resilient arm 71b and the electrode 24 are connected in conduction. Simultaneously, when the adhesive agent 73 has a heat curing property, the adhesive agent 73 is heat cured by the heat treatment and the LED 13 and the mother board 20 are fixedly bonded.

In this manner, the resilient contact point 71 having different internal stresses and hence being deformed by the difference in internal stress of itself without depending on the mechanical machining is also employed.

In the embodiment shown in FIG. 10, a contact point 80 is formed on the lower surface 13a of the LED 13. The contact point 80 includes, for example, a metallic plate 81 and a resilient member 83 formed of rubber or elastomer provided thereon, and a film 82 formed with a conductive pattern on the surface thereof covering a lower surface and side surfaces of the metallic plate 81 and an upper surface and side surfaces of the resilient member 83. The upper surface of the film 82 is bonded to the lower surface 13a of the LED 13. In the embodiment shown in FIG. 10, the contact point 80 includes the metal plate 81, the resilient member 83 and the film 82, and a resilient force is applied to the contact point 80 downward from the resilient member 83, so that the contact point 80 is pressed against the electrode 24 of the mother board 20. Between the contact point 80 and the electrode 24 are connected in conduction by a tunnel effect.

In an embodiment shown in FIG. 10, a resilient force is not generated in the film 82 in itself which is a substantial contact point with the electrode 24. However, by providing the resilient member 83, a resilient force acts on the contact point 80 secondarily. In this manner, the contact point having applied with the secondary resilient force is also included in the “resilient contact point” in the invention. In embodiments other than the one shown in FIG. 10, a form in which the secondary resilient force may be applied to the contact point 80 by providing the resilient member 83, for example, between the upper case 6 and the LED/microphone device sheet 10 shown in FIG. 3.

In the embodiments shown in FIG. 1 to FIG. 10, the LEDs 13 or the microphone device 14 are supported on the back surface 11a of the sheet member 11 supporting the reversing plates 12. Then, the resilient contact points 17 are attached to the lower surfaces 13a, 14a of the LEDs 13 and the microphone device 14. The resilient contact points 17 are connected in conduction to the electrodes 23, 24 formed on the surface of the mother board 20 or the like. In this embodiment, the resilient contact points 17 are provided on the lower surfaces of the LEDs 13 or the microphone device 14, so that the conduction with the electrodes 23, 24 is achieved under the lower surfaces of the LEDs 13 or the microphone device 14. Therefore, the mounting space can be reduced in comparison with the case in which the LEDs 13 and the microphone device 14 are mounted, for example, by wire bonding or the like. Therefore, downsizing of the cellular phone 1 is achieved.

What is necessary is just to mount the respective LEDs 13 and the microphone device 14 on the side of the sheet member 11 and install the seat member 11 on the mother board 20, and hence the LEDs 13 and the microphone device 14 can be mounted in the input device easily without considering the state of the surface of the mother board 20 or the size of the mother board 20 in itself in comparison with the case in which the LEDs 13 or the microphone device 14 are mounted directly to the mother board as in the related art.

In the related art, the LEDs 13 or the microphone device 14 are mounted to the mother board 20 by reflow soldering or the like. However, in this embodiment, by supporting the LEDs 13 or the microphone device 14 on the back surface 11a of the sheet member 11 that supports the reversing plates 12, the back surface 11a of the sheet member 11 can be utilized efficiently, and in particular, the LEDs 13 and the microphone device 14 can be adequately connected in conduction to the electrodes 23, 24 on the mother board 20. According to these embodiments, by the provision of the resilient contact points 17 on the lower surfaces 13a, 14a of the LED 13 and the microphone device 14, the resilient contact points 17 are adequately pressed against the electrodes 23, 24 by a resilient force (it must not be a spontaneous resilient force, and may be an auxiliary resilient force) of the resilient contact point 17, and hence the resilient contact points 17 and the electrodes 23, 24 are reliably connected in conduction.

It is also possible to use the front surface 20a of the mother board 20 as the surface for forming the electrode pattern and the back surface 20b of the mother board 20 as the mounting surface for mounting the semiconductor device 35 as in the embodiment shown in FIG. 2 to FIG. 4 or, alternatively, it is possible to provide the electrode sheet 40 between the mother board 41 and the LED/microphone device sheet 10 and use the upper and lower surfaces of the mother board 41 as the mounting surface of the semiconductor device 35 as in the embodiment shown in FIG. 5 and FIG. 6.

When the structure in which the resilient contact points 17 are configured as the contact point modules 50 as shown in FIG. 12 and the bumps 51 that constitute the contact point modules 50 are press-fitted into the recesses formed on the lower surfaces 13a, 14a of the LEDs 13 and the microphone device 14 to support the contact point modules 50 is employed, the resilient contact points 17 can be mounted easily and adequately to the LEDs 13 and the microphone device 14.

In the embodiment described above, the LEDs 13 and the microphone device 14 are supported on the back surface 11a of the sheet member 11 on which the reversing plates are supported. However, it may be a configuration in which at least one of the LEDs 13 or the microphone device 14 are/is supported by the back surface 11a of the sheet member 11. For example, when the microphone device 14 is not supported by the seat member 11, the microphone device 14 is mounted to the surface 20a of the mother board 20. Although a plurality of the LEDs 13 are normally provided, at least one of the LEDs 13 must simply be supported on the back surface 11a of the sheet member 11. The LEDs 13 which are not supported on the back surface 11a of the sheet member 11 are mounted to the front surface 20a of the mother board 20.

The LEDs 13 may be organic ELs (electroluminescence) 90 as shown in FIG. 11. In FIG. 11, the organic EL 90 is mounted to the back surface 11a of the seat member 11 on which the reversing plates 12 are mounted. A most basic structure of the organic EL 90 is composed of three layers including a light-emitting layer 91 and electrode layers 92, 93 formed on the upper and lower sides thereof. In order to allow light from the light-emitting layer 91 to be taken out, one of the electrodes 92, 93 is formed into a transparent electrode. Normally, ITO is used for an anode. As shown in FIG. 11, the resilient contact points 17 to be connected to the respective two electrodes 92, 93 are mounted to the lower surface of the organic EL 90.

In the case of the sheet member used inside the operating unit 2, a structure in which the LEDs or the organic ELs, or the electronically functioning device such as the microphone device are mounted to the back surface of the sheet member is also included in the embodiment of the invention irrespective of whether or not the reversing plates 12 are mounted to the back surface of the sheet member. For example, a structure in which the reversing plates 12 shown in FIG. 3 are provided directly on the mother board 20 and the reversing plates 12 are not mounted to the LED/microphone device sheet 10 is also applicable. For example, a structure in which the upper case 6 shown in FIG. 3 is not provided, the surface of the operating unit 2 is composed of the sheet member (surface sheet member) formed of resin sheet such as PET or silicone rubber, assignment displays which indicate a plurality of independent input positions such as the characters, numerical characters or signs are formed on the surface (operating surface 2a) by printing process or transferring process, and the LEDs 13 or the like is mounted to the back surface of the front sheet member is also applicable. In this case, the reversing plates 12 do not necessarily have to be mounted to the back surface of the front sheet member (the reversing plates 12 may be mounted as a matter of course).

In the embodiment shown in FIG. 1, the input device having the LED/microphone sheet, the mother board, and so on is used in the internal structure of the operating unit 2 of the cellular phone 1 as shown in FIG. 1. However, the input device may be used in the electronic equipment other than the cellular phone. In particular, it is preferably used for portable electronic equipment, and if it is mounted in the device other than the cellular phone, it can be used effectively in, for example, remote controllers. The embodiment can be used as the internal structure of the display unit 4 of the devices other than the operating unit 2 as a matter of course.

The form of the resilient arm of the resilient contact point is not limited to the spiral shape as shown in FIG. 12. However, when the resilient arm has the spiral shape, a contact surface area of the resilient arm with respect to the electrode surface can easily be increased, and since adequate contact of the resilient arm with the electrode is ensured irrespective of the shape of the electrode, and in particular, the conductivity with respect to the electrode can be easily ensured even when an impact or the like is applied thereto. Therefore, the spiral shape is preferably as the resilient arm.

What is claimed is:

1. An electronically functioning device module comprising:
at least one electronically functioning device supported on a back surface of a supporting member that supports a reversing plate that is reversed by being pressed,
wherein a resilient contact point is mounted to the electronically functioning device.

2. The electronically functioning device according to claim 1, wherein the reversing plate is formed of a dome-shaped metal plate.

3. An electronically functioning device module comprising:
at least one electronically functioning device supported on a back surface of at least one supporting member that constitutes electronic equipment,
wherein a resilient contact point is mounted to the electronically functioning device.

4. The electronically functioning device module according to claim 1, wherein the electronically functioning device is a light-emitting device.

5. The electronically functioning device module according to claim 1, wherein the electronically functioning device is a microphone device.

6. The electronically functioning device module according to claim 1, wherein the resilient contact point and an electrode are connected in conduction via a bump by mounting the bump to the resilient contact point, forming a recess on the electronically functioning device, the electrode is provided in the recess, and inserting the bump into the recess.

7. The electronically functioning device module according to claim 6, wherein the bump is press-fitted into the recess.

8. The electronically functioning device module according to claim 1, wherein the resilient contact point is formed so as to project from a proximal end to a distal end in a spiral shape.

9. An input device comprising:
the electronically functioning device module according to claim 1, and
a member having an electrode,
wherein the electrode and the electronically functioning device module are opposed to each other and the resilient contact point and the electrode are connected in conduction.

10. The input device according to claim 9, wherein the member having the electrode is a mother board, and the electronically functioning device module opposes the mother board so that the resilient contact point and the electrode are connected in conduction.

11. The input device according to claim 10, wherein the electronically functioning device module according to claim 2 is used, and a supporting electrode that is connected to a proximal portion of the reversing plate and a central electrode that comes in contact with the reversing plate when the reversing plate is reversed are formed on the mother board.

12. The input device according to claim 9 comprising:
the electronically functioning device module;
the member having the electrode; and
the mother board,
wherein the electronically functioning device module opposes the electrode so that the resilient contact point and the electrode is connected in conduction, and the mother board is arranged on the lower side of the member having the electrode.

13. The input device according to claim 12, wherein the electronically functioning device module according to claim 2 is used, and a supporting electrode that is connected to the proximal portion of the reversing plate and a central electrode that comes in contact with the reversing plate when the reversing plate is reversed are formed on the member having the electrode.

14. Electronic equipment comprising the input device according to claim 9.

15. The electronic equipment according to claim 14, wherein the electronic equipment is portable electronic equipment.

16. The electronic equipment according to claim 15, wherein the portable electronic equipment is a cellular phone.
